(19) United States
(12) Patent Application Publication
(10) Pub. No.: US 2025/0175959 A1
(43) Pub. Date: May 29, 2025

(54) METHOD AND SYSTEM FOR PROVIDING MULTIPLE RESOURCE UNITS AND MULTIPLE DISTRIBUTIVE RESOURCE UNITS IN IEEE 802.11

(71) Applicant: HUAWEI TECHNOLOGIES CO., LTD., SHENZHEN (CN)

(72) Inventors: Jung Hoon SUH, Kanata (CA); Yan XIN, Kanata (CA); Osama ABOUL-MAGD, Kanata (CA); Kwok Shum AU, Kanata (CA)

(73) Assignee: HUAWEI TECHNOLOGIES CO., LTD., SHENZHEN (CN)

(21) Appl. No.: 18/915,872

(22) Filed: Oct. 15, 2024

Related U.S. Application Data
(60) Provisional application No. 63/559,560, filed on Feb. 29, 2024.
(60) Provisional application No. 63/602,419, filed on Nov. 23, 2023.

(51) Int. Cl. H04W 72/0453; H04L 5/00; H04W 72/12; H04W 84/12

(52) U.S. Cl. CPC H04W 72/0453; H04L 5/0007; H04W 72/12; H04W 84/12

(57) ABSTRACT

A method, system and apparatus for subcarrier allocation to two or more dRUs or two or more RUs associated with a same device is provided. Subcarrier allocation includes scheduling 106 tones to each dRU or each RU associated with the device. Tone alignment, defining unusable or unused tones reserved for other purposes, is provided across different carrier bandwidths enabling mixed scheduling for devices operating at different carrier frequencies.

### CROSS-REFERENCE TO RELATED APPLICATIONS

This application claims priority to U.S. Provisional Patent Application No. 63/559,560, filed Feb. 29, 2024, and to U.S. Provisional Patent Application No. 63/602,419, filed Nov. 23, 2023, the contents of which are incorporated herein by reference.

### FIELD OF THE INVENTION

The present invention pertains to wireless communication systems, and in particular to a method and apparatus for resource units and distributive resource units in IEEE 802.11 wireless communication systems.

### BACKGROUND

Wireless communication systems such as IEEE 802.11ac (WI-FI® 5; WI-FI® is a registered trademark of Wi-Fi Alliance, Austin, TX, USA) and IEEE 802.11ax (WI-FI® 6) systems need to meet the govern-regulated power spectral density (PSD) requirements, which lays the limit in the upper bound on the transmitter (TX) power at, for example, every one (1) megahertz (MHz). The total TX power has also been regulated.

In wireless communication systems (such as IEEE 802.11ax (WI-FI® 6) systems) using orthogonal frequency division multiple access (OFDMA; which uses orthogonal frequency division multiplexing (OFDM) for multiple access), the resource unit (RU) is the OFDMA scheduling unit. In conventional wireless communication technologies, a RU usually only occupies a sub-bandwidth of consecutive subcarriers of the OFDM frame according to the size of the RU.

When using OFDMA, different RUs may be used with different TX power. However, the government-regulated PSD requirements limit the TX power that can be used in RUs.

Current and next-generation networks include an increasing number of devices requiring effective and simultaneous data transmission. Existing multiple RU (MRU) patterns available in the Extremely High Throughput (EHT) communication system standards (e.g., IEEE 802.11be WI-FI® 7) include 106+26 tone small MRU and 52+26 tone small MRU patterns, where the small size MRU means the MRU with the size smaller than 20 MHz. In wireless communications, distributed RUs (dRUs) have been considered as offering an advantage or boosted transmission power and improved coverage. However, specific tone allocations for RUs and dRUs that a re broadly applicable across a range of bandwidths have not been well-defined.

Therefore, there is a need for a method and apparatus for scheduling of resource units and distributive resource units in IEEE 802.11 and similar wireless communication systems that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present disclosure is to provide a method and apparatus for providing multiple resource units (MRUs, as of Wi-FI® 7, IEEE 802.11be)) and/or multiple distributive resource units (MdRUs) in IEEE 802.11 wireless communications systems. A MdRU is comparable to an MRU, but with the constituent tones being distributed and/or interleaved across a frequency band rather than contiguous.

In accordance with embodiments of the present disclosure, the communication network conforms to the IEEE 802.11be standard or an IEEE 802.11 standard subsequent to the IEEE 802.11be standard. Accordingly, methods and systems disclosed herein may be configured to conform, comply or be compatible with any one or more of such standards.

In accordance with embodiments of the present disclosure, there is provided a method for allocating tones or subcarriers to multiple distributive resource units (dRUs) such that 106 individual subcarriers (i.e. tones) are allocated to each of two or more dRUs associated to a same device, such as a mobile or stationary station (STA) or an access point (AP) spanning the bandwidth (BW).

In accordance with embodiments of the present disclosure, alignment of unusable tones across various operating BWs (such as 20, 40, 80, 160, and/or 320 MHz BWs), devices, such as an STA or an AP with different operating BWs, may be scheduled together with respective dRU tone plans comprising a 106+106 tone allocation for two or more dRUs associated with a same device.

In accordance with embodiments of the present disclosure, there is provided a method for scheduling multiple distributive resource units (dRUs) to a device of a communication network. The method includes scheduling a first dRU and a second dRU to a first device of the communication network. 106 usable tones of a plurality of usable tones spanning a bandwidth (BW) are allocated to the first dRU, and another 106 usable tones, distinct from the 106 usable tones allocated to the first dRU, of the plurality of usable tones spanning the BW are allocated to the second dRU. The method may further include performing such an allocation.

In accordance with embodiments of the present disclosure, there is provided a method for scheduling multiple distributive resource units (dRUs) to devices of a communication network. The method includes scheduling a first dRU and a second dRU to a first device operable in the communication network. A first respective 106 usable tones of a plurality of usable tones spanning at least a portion of a bandwidth (BW) are allocated to the first dRU, and a second respective 106 usable tones, distinct from the 106 usable tones are allocated to the first dRU, of the plurality of usable tones spanning at least the portion of the BW to a second dRU. The method may include providing another respective 106 usable tones of the plurality of usable tones spanning at least another portion of the BW to a third dRU, providing further respective 106 usable tones of the plurality of usable tones spanning at least the other portion of the BW to a fourth dRU, and scheduling the third dRU and the fourth dRU to a second device operable in the communication network.

In accordance with embodiments of the present disclosure, there is provided a method for supporting usage, by a device, of a communication network using orthogonal frequency division multiple access (OFDMA). The method includes allocating, to the device and for concurrent use in transmission, a first 106 usable tones of a plurality of usable tones and a second 106 usable tones, distinct from the first 106 usable tones, of the plurality of usable tones. The first 106 usable tones are allocated to a first resource unit (RU) or a first dRU. The second 106 usable tones are allocated to a second RU or a second dRU.

In some implementations, one or more unusable tones, different from the first 106 usable tones and the second 106 usable tones may be defined. The first RU, the first dRU, the second RU and the second dRU may be selected from a plurality of potential tone plans, and each of the plurality of potential tone plans may exclude the one or more unusable tones.

In some implementations, the first RU or the first dRU may be the first RU, and the second RU or the second dRU may be the second RU. The first RU may span a first portion of an overall BW and the second RU may span a second portion of the overall BW, the second portion being different from the first portion. The first portion may be adjacent in frequency to the second portion.

In some implementations, the first RU or the first dRU may be the first dRU, and the second RU or the second dRU may be the second dRU. The first dRU and the second dRU may span a same BW. At least two neighbouring usable tones of the first 106 usable tones allocated to the first dRU may be separated by one or more usable tones of the second 106 usable tones allocated to the second dRU. The first 106 usable tones allocated to the first dRU may be partially or fully interleaved with the second 106 usable tones allocated to the second dRU.

In some implementations, the method may be performed by a scheduler. The allocating the first RU or the first dRU, the second RU or the second dRU to the device, may include scheduling of the first RU or the first dRU and scheduling of the second RU or the second dRU.

In some implementations, the method may be performed by the device and include transmitting one or both of the first RU or the first dRU, and the second RU or the second dRU.

In some implementations, the method may include allocating usage, by a second device of the communication network using OFDMA, the usage being concurrent with the usage by the device. Such allocating usage may include allocating, to the second device and for concurrent use in transmission, a third 106 usable tones, distinct from the first 106 usable tones and the second 106 usable tones, of the plurality of usable tones, and a fourth 106 usable tones, distinct from the first 106 usable tones and the second 106 usable tones and the third 106 usable tones, of the plurality of usable tones. The third 106 usable tones may be allocated to a third RU or a third dRU, and the fourth 106 usable tones may be allocated to a fourth RU or a fourth dRU.

In some implementations, the third RU or the third dRU may be the third RU, and the fourth RU or the fourth dRU may be the fourth RU.

In some implementations, the third RU or the third dRU may be the third dRU, and the fourth RU or the fourth dRU may be the fourth dRU. The first dRU and the second dRU may span a same first BW, and the third dRU and the fourth dRU may span a same second BW. The first BW may be non-overlapping with the second BW.

In some implementations, the method may be performed by a scheduler, such that the allocating the first RU or the first dRU, the second RU or the second dRU to the device, and the allocating the third RU or the third dRU and the fourth RU or the fourth dRU to the second device, includes scheduling of RUs or dRUs.

In some implementations, the method may be performed by the device and the second device in combination. The method may include transmitting one or more of the first RU or the first dRU, the second RU or the second dRU, the third RU or the third dRU, and the fourth RU or the fourth dRU.

In accordance with embodiments of the present disclosure, there is provided a method, for execution by a computer or other type of electronic controller (e.g. by an apparatus such as is described above). The method includes operations to provide an allocation pattern, spanning the BW, comprising allocating at least 106 respective tones of a plurality of tones spanning the BW to each dRU of two or more dRUs, as described herein.

In accordance with embodiments of the present disclosure, there is provided an apparatus comprising processing electronics and/or a wireless transmitter/receiver and configured to operate as described herein.

In accordance with embodiments of the present disclosure, there is provided an apparatus which may include a computer or other type of electronic controller, or an electronic device, or a chipset such as a wireless transceiver chipset. Such apparatuses may also include sensors, actuators, transmitters, receivers, or a combination thereof. The sensors may obtain information from the physical environment. The apparatus may be configured to cause scheduling of two or more dRUs each having 106 distinct tones to a same device, or at least create signals which ultimately result in such scheduling. The transmitters and receivers may be used to interact with other entities inside or outside the communication network comprising at least one device and at least two dRUs. The transmitter(s) may transmit the at least two dRUs. Such transmitting may be done concurrently. The apparatus is configured to implement methods as described above and elsewhere herein, including scheduling of at least two dRUs of the two or more dRUs to a same device. The apparatus may further be configured to obtain information for use in the allocating of respective tones to dRUs and scheduling the at least two dRUs to a same device of the communication network.

In accordance with embodiments of the present disclosure, there is provided an apparatus for supporting usage, by a device, of a communication network using OFDMA. The apparatus includes processing electronics and a wireless transmitter and is configured to allocate, to the device and for concurrent use in transmission, a first 106 usable tones of a plurality of usable tones, and a second 106 usable tones, distinct from the first 106 usable tones, of the plurality of usable tones. The first 106 usable tones are allocated to a first RU or a first dRU, and the second 106 usable tones are allocated to a second RU or a second dRU.

In some implementations, the apparatus may be a scheduler or the device.

In accordance with embodiments of the present disclosure, there is provided an apparatus for scheduling usage, by a first device and a second device, of a communication network using OFDMA. The apparatus includes processing electronics and a wireless transmitter and is configured to schedule, to the first device, for concurrent use in transmission, a first 106 usable tones of a plurality of usable tones, and a second 106 usable tones, distinct from the first 106 usable tones, of the plurality of usable tones. The apparatus is configured to schedule usage, by the second device, of the communication network using OFDMA, the usage being concurrent with the usage by the device. Such usage scheduling includes scheduling, to the second device, for concurrent use in transmission, a third 106 usable tones, distinct from the first 106 usable tones and the second 106 usable tones, of the plurality of usable tones, and a fourth 106 usable tones, distinct from the first 106 usable tones and the second 106 usable tones and the third 106 usable tones, of the plurality of usable tones. Such first 106 usable tones are allocated to a first RU or a first dRU, such second 106 usable tones are allocated to a second RU or a second dRU, such third 106 usable tones are allocated to a third RU or a third dRU, and such fourth 106 usable tones are a fourth RU or a fourth dRU.

According to embodiments, multiple methods or apparatuses may interact together in a system, each method or apparatus as described above, and in the presence of each other.

Embodiments have been described above in conjunctions with aspects of the present disclosure upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present disclosure will become apparent from the following detailed description, taken in combination with the appended drawings, in which:

FIG. 1 illustrates a schematic diagram of a communication system, according to some embodiments of this disclosure.

FIG. 2 illustrates a schematic diagram of an access point (AP) of the communication network of the communication system shown in FIG. 1, according to embodiments of the present disclosure.

FIG. 3 illustrates a schematic diagram of a station (STA) of the communication system shown in FIG. 1, according to embodiments of the present disclosure.

FIG. 4A is a schematic diagram showing a partially interleaved allocation of tones to two distributive resource units (dRUs) across a 20 megahertz (MHz) bandwidth of orthogonal frequency-division multiple access (OFDMA), according to an embodiment of the present disclosure.

FIG. 4B is a schematic diagram showing an interleaved allocation of tones to two distributive resource units (dRUs) across a 20 megahertz (MHz) bandwidth of orthogonal frequency-division multiple access (OFDMA), according to an embodiment of the present disclosure.

FIGS. 5A-B illustrate a schematic diagram of a partially interleaved allocation of tones to two distributive resource units (dRUs) across a 40 megahertz (MHz) bandwidth of orthogonal frequency-division multiple access (OFDMA), according to an embodiment of the present disclosure.

FIG. 6 is a schematic diagram showing a non-interleaved allocation of tones to two resource units (RUs) across a 20 megahertz (MHz) bandwidth of orthogonal frequency-division multiple access (OFDMA), according to an embodiment of the present disclosure.

FIG. 7 is a schematic illustration of an electronic device that may perform any or all of operations of the methods and features explicitly or implicitly described herein, according to embodiments of the present disclosure.

It will be noted that throughout the appended drawings, like features are identified by like reference numerals.

### DETAILED DESCRIPTION

The present disclosure sets forth various embodiments via the use of block diagrams, flowcharts, and examples. Insofar as such block diagrams, flowcharts, and examples contain one or more functions and/or operations, it will be understood by a person skilled in the art that each function and/or operation within such block diagrams, flowcharts, and examples can be implemented, individually or collectively, by a wide range of hardware, software, firmware, or combination thereof. As used herein, the term “about” should be read as including variation from the nominal value, for example, a +/−10% variation from the nominal value. It is to be understood that such a variation is always included in a given value provided herein, whether or not it is specifically referred to.

Embodiments of the present disclosure pertain to methods, apparatuses and systems for wireless communication employing multiple distributive resource units or multiple resource units. The wireless communication systems, apparatuses, and methods disclosed herein may be any suitable systems, apparatuses, and methods for transmitting wireless signals. Non-limiting examples of such systems include wireless local-area network (WLAN) Ultra High Reliability (UHR) systems (for example, IEEE 802.11bn or WI-FI® 8 systems), 5G or 6G wireless mobile communication systems, and the like.

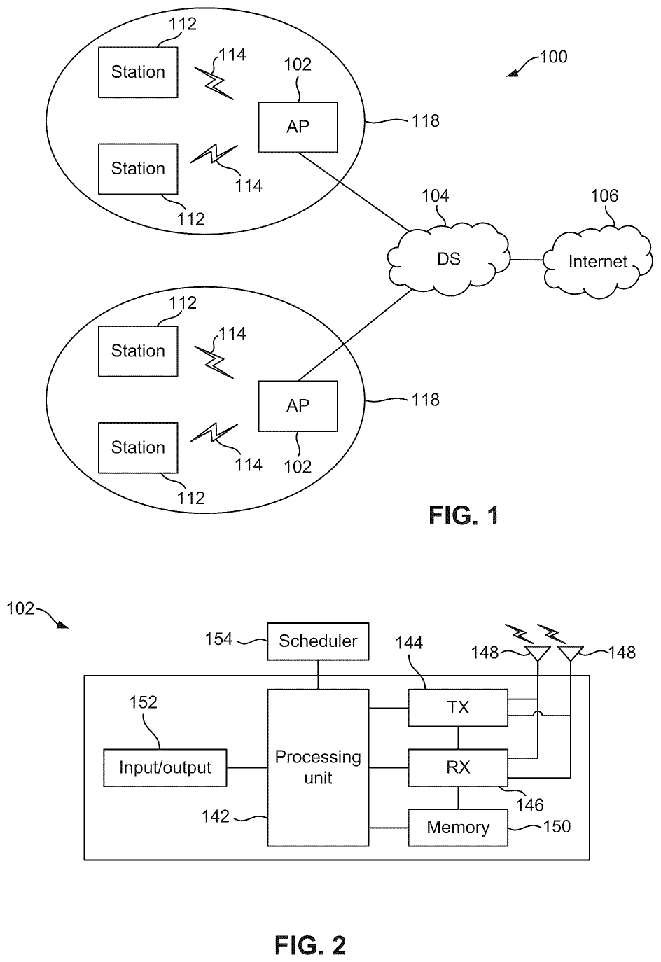

FIG. 1 shows a communication system 100 according to some embodiments of the present disclosure. The communication system 100 may be a WI-FI® system built under relevant standards, such as IEEE 802.11 standard (e.g., WI-FI® 8, IEEE 802.11bn, the IEEE 802.11be standard or another IEEE 802.11 standard subsequent to the IEEE 802.11be standard), for example, for a wireless local area network (WLAN) prioritizing Ultra High Reliability (UHR). The communication system 100 includes a plurality of interconnected networking devices 102, such as a plurality of interconnected access points (APs such as WI-FI® 8 APs; also referred to herein as “base stations”) forming a distribution system (DS) 104 which is connected to other networks, such as the Internet 106, which may include a network of computers and subnets (intranets) or both, and incorporate protocols, such as Internet Protocol (IP), Transmission Control Protocol (TCP), User Datagram Protocol (UDP), and/or the like.

Each AP 102 is in wireless communication with one or more mobile or stationary stations 112 (STAs) through respective wireless channels 114 for providing wireless network connections thereto. Herein, the APs 102 and STAs 112 may be considered as different types of network nodes (or simply “nodes”) of the communication system 100. Together, each AP 102 and the STAs 112 connected thereto form a cell or basic service set (BSS) 118.

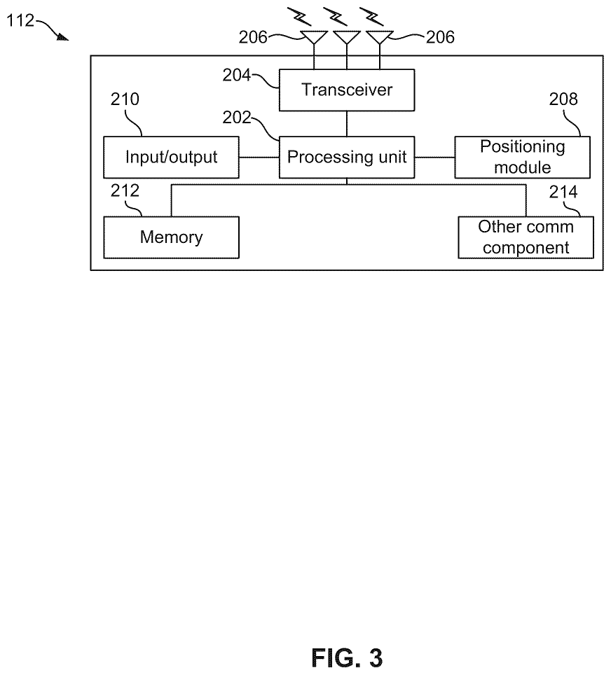

FIG. 2 shows a schematic diagram of an AP 102 of FIG. 1. The AP 102 includes at least one processing unit 142 (also denoted at least one “processor”), at least one transmitter (TX) 144, at least one receiver (RX) 146 (collectively referred to as a transceiver), one or more antennas 148, at least one memory 150, and one or more input/output components or interfaces 152. A scheduler 154 may be coupled to the processing unit 142. The scheduler 154 may be included within or operated separately from the AP 102. Each of these components 142 to 154 may be implemented as one or more circuits (such as one or more electronic circuits and/or one or more optical circuits). Alternatively, the ensemble of these components 142 to 154 may be implemented as one or more circuits.

The processing unit 142 is configured for performing various processing operations, such one or more of: as signal coding, data processing, power control, input/output processing, and any other suitable functionalities. The processing unit 142 may include one or more of: a microprocessor, a microcontroller, a digital signal processor, a FPGA, an ASIC, and/or the like. In some embodiments, the processing unit 142 may execute computer-executable instructions or code stored in the memory 150 to perform some or all of methods and procedures described herein.

Each transmitter 144 may include any suitable structure for generating signals, such as control signals described elsewhere herein, for wireless transmission to one or more STAs 112. Each receiver 146 may include any suitable structure for processing signals received wirelessly from one or more STAs 112. Although shown as separate components, at least one transmitter 144 and at least one receiver 146 may be integrated and implemented as a transceiver. Each antenna 148 may include any suitable structure for transmitting and/or receiving wireless signals. Although common antennas 148 are shown in FIG. 2 as being coupled to both the transmitter 144 and the receiver 146, one or more antennas 148 may be coupled to the transmitter 144, and one or more other antennas 148 may be coupled to the receiver 146.

In some embodiments, an AP 102 may include a plurality of transmitters 144 and receivers 146 (or a plurality of transceivers) together with a plurality of antennas 148 for communication in its cell 118.

Each memory 150 may include any suitable volatile and/or non-volatile storage such as RAM, ROM, hard disk, optical disc, SIM card, solid-state memory, memory stick, SD memory card, and/or the like. The memory 150 may be used for storing instructions executable by the processing unit 142 and data used, generated, or collected by the processing unit 142. For example, the memory 150 may store instructions of software, software systems, or software modules that are executable by the processing unit 142 for implementing some or all of the functionalities and/or embodiments of the procedures performed by an AP 102 described herein.

The input/output component 152 enables interaction with a user or other device(s) in the communication system 100. Each input/output device 152 may include any suitable structure for providing information to or receiving information from a user and may be, for example, a speaker, a microphone, a keypad, a keyboard, a display, a touch screen, a network communication interface, and/or the like.

In embodiments, the STAs 112 may be any suitable wireless device that may join the communication system 100 via an AP 102 for wireless operation. In various embodiments, a STA 112 may be a wireless electronic device used by a human or user (such as a smartphone, a cellphone, a personal digital assistant (PDA), a laptop, a desktop computer, a tablet, a smart watch, a consumer electronics device, and/or the like). An STA 112 may be a wireless sensor, an Internet-of-things (IoT) device, a robot, a shopping cart, a vehicle, a smart TV, a smart appliance, a wireless transmit/receive unit (WTRU), a mobile station, or the like. Depending on the implementation or application, the STA 112 may be movable autonomously or under the direct and/or remote control of a human, or may be positioned at a fixed position.

In some embodiments, an STA 112 may be a multimode wireless electronic device capable of operation according to multiple radio access technologies and incorporate multiple transceivers necessary to support such.

In embodiments, some or all of the STAs 112 include functionality for communicating with different wireless devices and/or wireless networks via different wireless links using different wireless technologies and/or protocols. Instead of wireless communication (or in addition thereto), some or all of STAs 112 may communicate via wired communication channels to other devices or switches (not shown), and to the Internet 106. For example, a plurality of STAs 112 (such as STAs 112 in proximity with each other) may communicate with each other directly via suitable wired or wireless sidelinks.

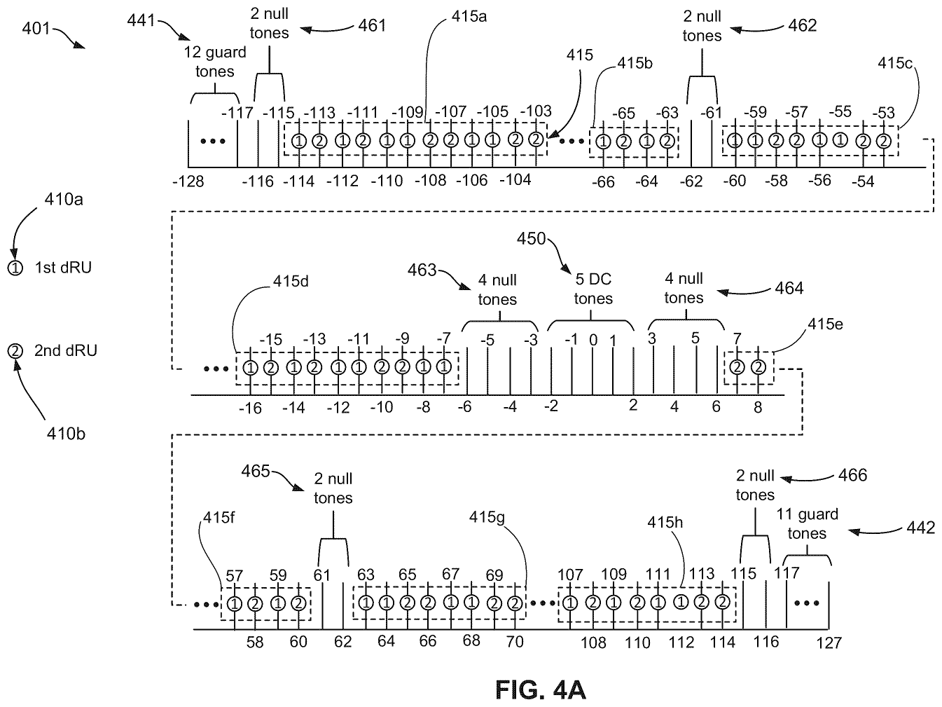

FIG. 3 shows a schematic diagram of an STA 112 of FIG. 1. The STA 112 includes at least one processing unit 202, at least one transceiver 204, at least one antenna or network interface controller (NIC) 206, at least one positioning module 208, one or more input/output components 210, at least one memory 212, and at least one other communication component 214. Each of these components 202 to 214 may be implemented as one or more circuits (such as one or more electronic circuits and/or one or more optical circuits, or a combination thereof). Alternatively, a combination of components 202 to 214 may be implemented as one or more circuits.

The processing unit 202 is configured for performing various processing operations such one or more of: as signal coding, data processing, power control, input/output processing, and any other suitable functionalities to enable the STA 112 to access and join the communication system 100 and operate therein. The processing unit 202 may be configured to implement some or all of the functionalities of the STA 112 disclosed herein. The processing unit 202 may include one of more of: a central processing unit (CPU), a microprocessor, a microcontroller, a digital signal processor, an accelerator, a graphic processing unit (GPU), a tensor processing unit (TPU), a FPGA, or an ASIC. Examples of the processing unit 202 may be an ARM® microprocessor (ARM is a registered trademark of Arm Ltd., Cambridge, UK) manufactured by a variety of manufactures such as Qualcomm of San Diego, California, USA, under the ARM® architecture, an INTEL® microprocessor (INTEL is a registered trademark of Intel Corp., Santa Clara, CA, USA), an AMD® microprocessor (AMD is a registered trademark of Advanced Micro Devices Inc., Sunnyvale, CA, USA), and the like. In some embodiments, the processing unit 202 may execute computer-executable instructions or code stored in the memory 212 to perform some or all of methods or processes described below.

The at least one transceiver 204 may be configured for modulating data or other content for transmission by the at least one antenna 206 to communicate with an AP 102. The transceiver 204 is also configured for demodulating data or other content received by the at least one antenna 206. Each transceiver 204 may include any suitable structure for generating signals for wireless transmission and/or processing signals received wirelessly. Each antenna 206 may include any suitable structure for transmitting and/or receiving wireless signals. Although shown as a single functional unit, a transceiver 204 may be implemented separately as at least one transmitter and at least one receiver.

The positioning module 208 is configured for communicating with a plurality of global or regional positioning devices, such as navigation satellites, for determining the location of the STA 112. The navigation satellites may be satellites of one or more of: a global navigation satellite system (GNSS) such as the Global Positioning System (GPS) of USA, Global′naya Navigatsionnaya Sputnikovaya Sistema (GLONASS) of Russia, the Galileo positioning system of the European Union, and/or the Beidou system of China, for example. The navigation satellites may also be satellites of a regional navigation satellite system (RNSS) such as the Indian Regional Navigation Satellite System (IRNSS) of India, the Quasi-Zenith Satellite System (QZSS) of Japan, or the like. In some other embodiments, the positioning module 208 may be configured for communicating with a plurality of indoor positioning devices for determining the location of the STA 112.

The one or more input/output components 210 is configured for interaction with a user or other devices in the communication system 100. Each input/output component 210 may include any suitable structure for providing information to or receiving information from a user and may be, for example, one or more of: a speaker, a microphone, a keypad, a keyboard, a display, a touch screen, and/or the like.

The at least one memory 212 is configured for storing instructions executable by the processing unit 202 and data used, generated, or collected by the processing unit 202. For example, the memory 212 may store instructions of software, software systems, or software modules that are executable by the processing unit 202 for implementing some or all of the functionalities and/or embodiments of the STA 112 described herein. Each memory 212 may comprise any suitable volatile and/or non-volatile storage and retrieval components such as one or more of: RAM, ROM, hard disk, optical disc, SIM card, solid-state memory modules, memory stick, SD memory card, and/or the like.

The at least one other communication component 214 is configured for communicating with other devices such as other STAs 112 via other communication means, such as one or more of: a radio link, a BLUETOOTH® link (BLUETOOTH is a registered trademark of Bluetooth Sig Inc., Kirkland, WA, USA), a wired sidelink, and/or the like. Examples of the wired sidelink may be a USB cable, a network cable, a parallel cable, a serial cable, and/or the like.

In some embodiments, an STA 112 may include a plurality of transceivers 204 and a plurality of antennas 206 for communication with an AP 102.

In the communication between the AP 102 and the STA 112, a transmission from the STA 112 to the AP 102 may typically be denoted as an uplink (UL), and the wireless channel used therefor is denoted an uplink channel. A transmission from the AP 102 to the STA 112 may typically be denoted as a downlink (DL), and the wireless channel used therefor is denoted a downlink channel. Suitable modulation technologies may be used for communication between the AP 102 and the STA 112. For example, in some embodiments, orthogonal frequency-division multiplexing (OFDM) may be used wherein the channel 114 is partitioned into a plurality orthogonal subchannels for communication between the AP 102 and the STA 112. In embodiments where a plurality of STAs 112 is in communication with a same AP 102, suitable multiple-access technologies may be used. For example, in some embodiments, orthogonal frequency-division multiple access (OFDMA) may be used for communication between the AP 102 and STAs 112.

Some wireless communication systems, such as IEEE 802.11ax (WI-FI® 6) and subsequent systems, use orthogonal frequency division multiple access (OFDMA) for multiple access. Generally, OFDMA uses orthogonal frequency division multiplexing (OFDM) for multiple users to transmit data at the same time.

For example, in an IEEE 802.11ax system, a device, such as an AP 102 or an STA 112, transmits data using physical layer protocol data units (PPDUs). A PPDU contains a preamble and a data field containing an OFDM symbol. As readily understood by a person skilled in the art, an OFDM symbol combines data elements into a plurality of subcarriers (also referred to as “tones”) and uses the so-called “cyclic prefix” for combating inter-symbol interferences. The number of tones in an OFDM symbol depends on the bandwidth (BW) thereof. In IEEE 802.11ax, the subcarrier spacing is 78.125 kilohertz (kHz), and the OFDM BW (that is, the BW of OFDM symbols; also denoted “OFDMA BW” when OFDMA is used) may be 20 MHz, 40 MHz, or 80 MHz. Correspondingly, the number of OFDM tones (that is, the tones in an OFDM symbol; also denoted “OFDMA tones” hereinafter when OFDMA is used) may be 256, 512, or 1024. Some of these tones are unused, including direct-current (DC) tones (also called direct-conversion tones, which include the tone whose frequency is equal to the RF carrier frequency, and some neighboring tones thereof), guard tones (also known as edge tones), and null tones. Therefore, the usable tones are generally a subset of the total OFDM tones.

When OFDMA is used, the usable OFDMA tones or subcarriers are partitioned into a plurality of resource units (RUs) for assigning (scheduling) to a plurality of users. In prior art, each RU (denoted “regular RU” or “rRU” hereinafter) consists of a plurality of consecutive tones, the consecutive tones being adjacent in frequency and forming a contiguous block of tones. The smallest number of tones of a RU is 26 tones which forms the base RU size and the bigger size of RU has been built up based on the 26-tone RU.

The document entitled “OFDMA Numerology and Structure” by S. Azizi et. al., published by IEEE 802.11 TGax, May 2015, 15/330r5, provides system-level simulation results of spectral efficiency over various RU sizes according to the IEEE channel types, for evaluating the spectrum efficiency over the various selections of the smallest OFDMA RU size. It is observed that spectrum efficiency starts to drop from the point of about 2.5 MHz RU size, and thus, the size of the smallest OFDMA RU needs to be about 2.5 MHZ, therefore the 26-tone has been set as the base RU size.

In embodiments, the wireless communication system 100 or more specifically a one or more AP 102 or one or more STA 112 thereof may use distributive RUs (dRUs), also known as distributed RUs, that may include non-consecutive subcarriers or tones that substantially span the whole BW or a portion thereof. More generally, a total number of subcarriers of a dRU is typically less that the total number of tones of the bandwidth, and the dRU subcarriers are distributed non-consecutively across the whole or a portion of the bandwidth that has more subcarriers that the dRU. Among the subcarriers or tones allocated to a dRU, at least two neighboring tones thereof may be non-consecutive, and separated by one or more tones not belonging to the dRU (that is, separated by one or more unusable tones and/or one or more tones of another dRU(s)). Thus, the subcarriers of the dRU may be allocated across the entire OFDMA BW. In other words, the nominal BW (from the lowest tone to the highest tone) of the dRU may occupy the entire OFDMA BW regardless of the size of the dRU.

In embodiments, the government-regulated power spectral density (PSD) requirements may be applied based on the OFDMA BW where the dRU-based OFDMA is scheduled, which is notably effective for an uplink (UL) OFDMA PPDU, for example. Consequently, the frequency diversity gain may be achieved with the spread subcarriers of the dRU across the entire PPDU, thereby providing additional benefit. The dRU may require a different dRU tone plan from the incumbent 802.11 high efficiency (HE) and extremely high throughput (EHT) OFDMA dRU tone plan, and may require new hardware implementation. Herein, a dRU tone plan is a specific arrangement of the dRUs within the OFDMA BW.

In the following, various embodiments of dRU tone plans according to various OFDMA BWs are described. rRU tone plans are also specified according to embodiments. Additionally, a “tone plan” or “collection of tones” is used herein to refer to a plurality of tones (subcarriers) which form either a rRU or a dRU, i.e. in which the constituent tones are either substantially contiguous with one another, in the case of a rRU, or at least partially non-contiguous in the case of a dRU.

Various embodiments provide for a method for supporting usage, by a device, of the communication network that uses OFDMA. Allocation of first 106 usable tones and second 106 usable tones distinct from the first 106 usable tones is described herein by way of illustrative example embodiments. The first 106 usable tones are allocated or assigned to a first RU or first dRU allocated to or associated with the device, and the second 106 usable tones are allocated or assigned to a second RU or second dRU allocated to or associated with the device. Allocation may be performed by the device or a scheduler (e.g., scheduler 154 of FIG. 2) configured to schedule the RUs, dRUs, or both for respective device(s). The device may be configured to transmit the first RU/dRU, the second RU/dRU, or both. In cases where a third RU/dRU and fourth RU/dRU are allocated to another device, both devices, in combination or cooperatively, or the scheduler can be configured to transmit or schedule, respectively, all allocated RUs/dRUs.

In embodiments, the first 106 usable tones may be allocated or assigned to the first RU or first dRU, and the second 106 usable tones may be allocated or assigned to the second RU or second dRU, respectively, thereby correspondingly resulting in an MRU or an MdRU allocated to or associated with the device.

In some embodiments, the usable OFDMA tones are partitioned to a plurality of dRUs.

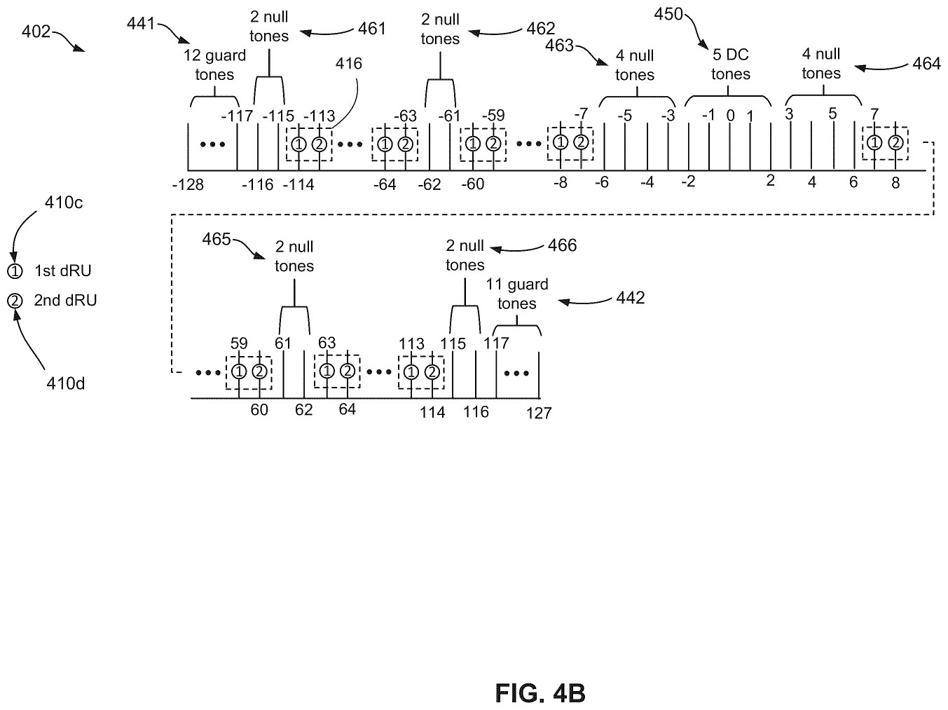

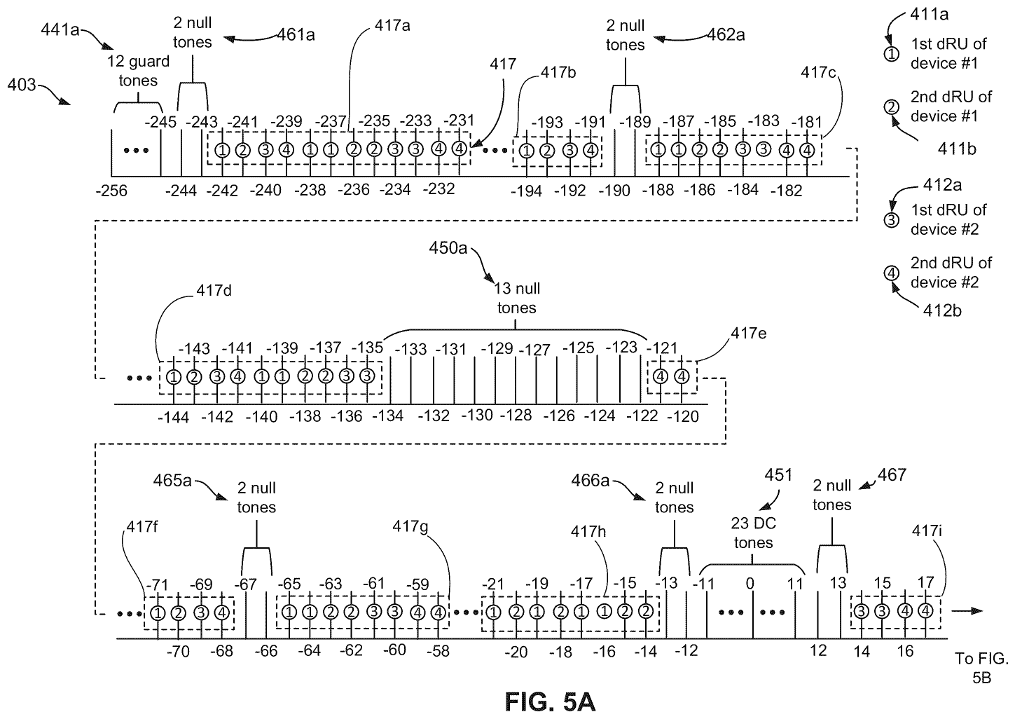

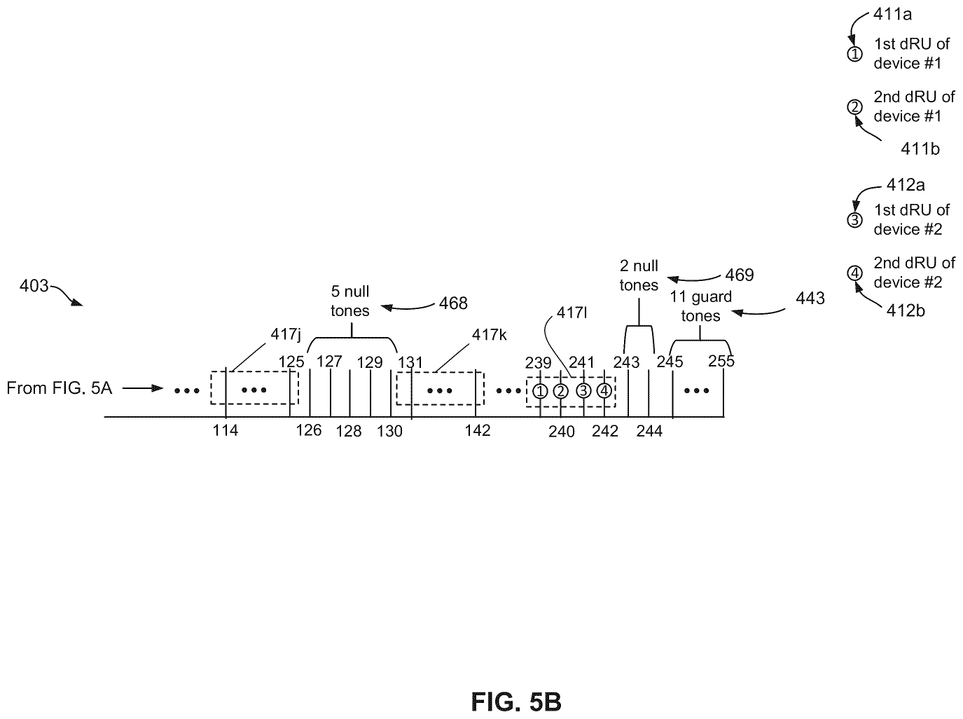

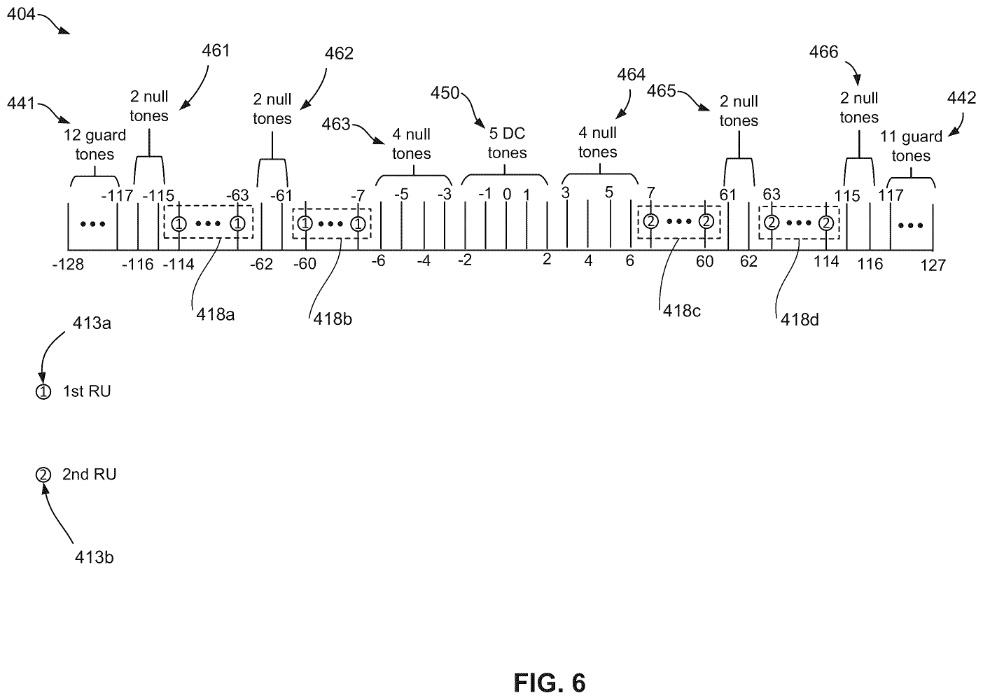

According to one such example partitioning, the unusable tones, such as the DC tones, guard tones, null tones, and the like, or a combination thereof, are aligned between different (e.g., two or more) OFDMA BWs, such that mixed scheduling between the STAs 112 using rRUs and the STAs using dRUs may be feasible. For example, unusable tones (12 tones 441 plus 2 tones 461=14 tones, 2 tones 462, 4 tones 463 plus 5 tones 450 plus 4 tones 464=13 tones, 3 tones 465, and 2 tones 466 plus 11 tones 442=13 tones) of the 20 MHz bandwidth allocation to RUs illustrated in FIG. 6 can be aligned with the unusable tones (12 tones 441a plus 2 tones 461a=14 tones, 2 tones 462a, 13 tones 450a, 2 tones 465a, and 2 tones 466a plus subsequent 11 tones of the 23 tones 451, respectively) of the 40 MHz bandwidth allocation to dRUs illustrated in FIG. 5A. Accordingly, different bandwidth allocations can have the same placement of unusable tones. Additionally or alternatively to facilitating the above noted mixed scheduling, such alignment of unusable tones between different OFDMA BWs facilitates interleaving of the (i.e., usable) tones of the dRUs. Interleaving of tones may be full or partial. Regarding the full interleaving, if the usable OFDMA tones are partitioned into N dRUs, and all usable tones are indexed consecutively (that is, the indexing not including the unusable tones) from the lowest tone to the highest tone, then the i-th dRU (i=1, 2, . . . , N) includes or has allocated thereto the following set of usable tones: [i, i+N, i+2N, i+3N, . . . ]. Fully interleaved allocation includes allocating tones such that no consecutive usable tones are allocated to a same dRU. The tones of a plurality of RUs are fully interleaved such that a tone of one of the plurality of RUs is an adjacent tone of a tone of another one of the plurality of RUs. Thus, dRUs of various sizes may be defined for various OFDMA BWs. An embodiment including fully interleaved tones is discussed elsewhere herein, for example with reference to FIG. 4B.

According to another such example partitioning, the tones of the dRUs may be partially interleaved. For example, a first dRU may use and have allocated thereto two or more consecutive usable OFDMA tones, while a second dRU may use and have allocated thereto one or more usable OFDMA tones immediately following the two or more tones allocated to the first dRU. In this case, the two or more consecutive usable OFDMA tones allocated to the first dRU are not interleaved because they consecutively are allocated only to the first dRU. More generally, for two (or more) dRUs each having 106 usable tones assigned thereto and spanning a same bandwidth, at least two neighbouring usable tones of the 106 usable tones allocated to one dRU may be separated by one or more usable tones of the 106 usable tones allocated to the other dRU. Some embodiments including partially interleaved tones are discussed elsewhere herein, for example with reference to FIGS. 4A and 5A-B.

Notably, allocation patterns that include a combination of full and partial interleaving may be provided, for example as described herein with reference to FIGS. 5A-5B, where e.g., a first set of tones -242, -241, -240, and -239 is fully interleaved and allocated to four different dRUs, and is followed by a second set of tones -238, -237, -236, -235, -234, -233, -232, and -231 that are partially interleaved having consecutive pairs of tones allocated to the four different dRUs of the first set.

According to a further such example partitioning, two dRUs (or RUs), each having 106 usable tones allocated thereto, are scheduled to a same device, such as same STA or a same AP.

In FIGS. 4A through 6, all tones (including all usable and unusable tones) are indexed consecutively, starting from the carrier frequency numbered or otherwise indexed as tone 0, and tones on the lower half of the BW (with respect to the carrier frequency) numbered or otherwise indexed as negative integers and tones on higher half of the BW numbered or otherwise indexed as positive integers. Moreover, the tones of different dRUs or RUs are represented by solid lines with different circle-enclosed numbers, wherein the tones having a same number belong to a same dRU or RU, respectively.

According to U.S. Provisional Patent Application No. 63/602,419 filed Nov. 23, 2023, unusable tones, such as the DC, guard tones (GT) and null tones can be aligned between different BWs from 20 MHz through 320 MHz. Considering for example, a 40 MHz BW (e.g., PPDU), a higher gain on the order of 1.86 times (a little less than 3 dB) higher may be achieved using the 242 tone dRU spread across the 40 MHz. Similarly, considering an 80 MHz BW (e.g., PPDU), a higher gain on the order of 3.25 times (a little less than 3 dB) higher may be achieved using the 242 tone dRU spread across the 80 MHz. Considering a total number of null tones, DC and guard tones that are needed in the 20 MHz BW to facilitate such alignment across BWs, a 242-tone dRU plan for 20 MHz BW is not feasible since insufficient number of usable tones remains after allocation of the unusable tones. Embodiments disclosed herein provide for tone plans, including tone plans that can be used in addition to or in replacement of such 242 tone dRU of 40 MHz and higher BWs.

Herein, various embodiments of distributive RUs (dRUs), RUs, or a both, and their arrangements are disclosed. In some embodiments, the dRUs, RUs, or both, and the arrangements thereof are for various BWs such as 20, 40, 80, 160, and 320 MHz BWs. The base size for the dRUs, RUs, or both, may be set to 106 tones and the larger-size dRUs may be arranged based on the 106-tone base dRU size. Thus, the base size of dRUs, RUs, or both, may not necessarily be bounded by the system throughput (which may affect the size of the RU). Moreover, the dRUs, RUs, or both, and their arrangements provide improved communication performance while meeting the government-regulated PSD requirements.

FIG. 4A shows allocation 401 of tones across a 20 MHz OFDMA BW (having 256 tones in total, based on the 78.125 kHz subcarrier spacing) to two dRUs assigned (scheduled) to a same STA or same AP such that the respective tones allocated to each dRU are partially interleaved, according to an embodiment. As shown, the 20 MHz OFDMA BW has 44 unusable tones and 212 usable tones. The 44 unusable tones include 12 guard tones 441 on the lower end of the BW followed by 2 null tones 461, 11 guard tones 442 on the higher end of the BW preceded by 2 null tones 466, 5 DC tones 450 (including one tone at the carrier frequency (indexed zero) and two tones on each side thereof) preceded by 4 null tones 463 and followed by 4 null tones 464, 2 null tones 462 indexed -62 and -63, and 2 null tones 465 indexed 61 and 62. The 212 usable tones include 106 tones on each side of the carrier frequency (tone indexed 0) and are partitioned to two partially interleaved dRUs (410a and 410b).

A first dRU 410a has 106 usable tones allocated thereto, and the second dRU 410b has 106 usable tones allocated thereto. Tone allocation follows a partially interleaved pattern 415 consecutively across the usable tones of the BW. The partially interleaved pattern 415 in this example includes a first tone (e.g indexed-114) allocated to the first dRU 410a, a second tone (e.g indexed-113) consecutive to the first tone and allocated to the second dRU 410b, a third tone (e.g indexed-112) consecutive to the third tone and allocated to the first dRU 410a, a fourth tone (e.g indexed-111) consecutive to the third tone and allocated to the second dRU 410b, a fifth tone (e.g indexed-110) consecutive to the fourth tone and allocated to the first dRU 410a, a sixth tone (e.g indexed-109) consecutive to the fifth tone and allocated to the first dRU 410a, a seventh tone (e.g indexed-108) consecutive to the sixth tone and allocated to the second dRU 410b, a eighths tone (e.g indexed-107) consecutive to the sevenths tone and allocated to the second dRU 410b, a ninth tone (e.g indexed-106) consecutive to the eighths tone and allocated to the first dRU 410a, a tenth tone (e.g indexed-105) consecutive to the ninth tone and allocated to the first dRU 410a, a eleventh tone (e.g indexed-104) consecutive to the tenth tone and allocated to the second dRU 410b, a twelfth tone (e.g indexed-103) consecutive to the eleventh tone and allocated to the second dRU 410b. Such pattern 415 may be referred to herein as “1-2-2-2-1-1-2-2-1-1-2-2” pattern. As readily understood by a person skilled in the art, other interleaved allocation patterns may be provided in various embodiments of the present disclosure.

The pattern 415 may include non-consecutive tones, such as partial pattern 415b and 415c together forming a single pattern 415 spaced by 2 null tones 462. In another example, the pattern 415 may include non-consecutive tones, such as partial pattern 415d and 415e together forming a single pattern 415 spaced by 4 null tones 462, 5 DC tones 450, and another 4 null tones 464. In an additional example, the pattern 415 may include non-consecutive tones, such as partial pattern 415f and 415g together forming a single pattern 415 spaced by 2 null tones 465. In case there is an insufficient number of usable tones remaining at the higher end of the BW to allocate the pattern 415 in full as described above, the pattern may include fewer tones, such as pattern instance 415h having 4 tones fewer, while maintaining the same tone allocation sequence (i.e. from left to right). Therefore, the allocation 401 includes 17 complete pattern instances (only some are illustrated for ease of illustration) of the 12-tone repeat pattern 415, and one incomplete instance 415h on the left-most end of the BW that includes only 8 tones.

In another embodiment, the respective tones allocated to the first dRU 410a and the second dRU 410b may be exchanged, such that all tones allocated to the first dRU 410a are allocated to the second dRU 410b and vice versa. Thereby, two different dRU tone plans can be provided based on the example embodiment of FIG. 4A.

FIG. 4B shows allocation 402 of tones across a 20 MHz OFDMA BW (having 256 tones in total, based on the 78.125 kHz subcarrier spacing) to two dRUs scheduled to a same STA or same AP such that the respective tones allocated to each dRU are interleaved, according to an embodiment. Usable and unusable tones are as described with reference to FIG. 4A above. The 212 usable tones include 106 tones on each side of the carrier frequency (tone indexed 0) and are partitioned to two interleaved dRUs (a first dRU 410c and a second dRU 410d).

As further shown in FIG. 4B, the first dRU 410c has 106 usable tones allocated thereto, and the second dRU 410d has 106 usable tones allocated thereto. Tone allocation follows an interleaved pattern 416 consecutively across the usable tones of the BW. The interleaved pattern 416 in this example includes a first tone (e.g. indexed-114,-64, etc.) allocated to the first dRU 410c, and a second tone (e.g. indexed-113,-63, etc., respectively) consecutive to the first tone and allocated to the second dRU 410d, repeated across the BW. Such pattern 416 may be referred to herein as “1-2” pattern. Although not illustrated in this example, in embodiments, an interleaved pattern, such as pattern 416, may include non-consecutive tones, and/or fewer tones in case of insufficient usable tones to complete a pattern instance at the higher end of the BW, as described elsewhere, for example with reference to FIG. 4A. Therefore, the allocation 402 in this example includes 106 complete instances of the pattern 416 spanning the BW.

In another embodiment, the respective tones allocated to the first dRU 410c and the second dRU 410d may be exchanged, such that all tones allocated to the first dRU 410c are allocated to the second dRU 410d and vice versa. Thereby, two different dRU tone plans can be provided based on the example embodiment of FIG. 4B.

FIGS. 5A and 5B show allocation 403 of tones across a 40 MHz OFDMA BW (having 512 tones in total, based on the 78.125 kHz subcarrier spacing) to two dRUs (first dRU 411a and second dRU 411b) assigned (scheduled) to one STA or one AP (i.e. device #1) and another two dRUs (third dRU 412a and fourth dRU 412b) assigned (scheduled) to another STA or another AP (i.e. device #2) such that the respective tones allocated to each dRU are partially interleaved, according to an embodiment. As shown, the 40 MHz OFDMA BW has 76 unusable tones and 436 usable tones. The 76 unusable tones include 12 guard tones 441a on the lower end of the BW followed by 2 null tones 461a, 11 guard tones 443 on the higher end of the BW preceded by 2 null tones 469, 23 DC tones 451 (including one tone at the carrier frequency (indexed zero) and 11 tones on each side thereof) preceded by 2 null tones 466a and followed by 2 null tones 467, 2 null tones 462a indexed-190 and-189, 13 null tones 450a indexed-134 through-122, 2 null tones 465a indexed-67 and-66, 5 null tones 468 indexed 136 through 130, and 2 null tones 469 indexed 243 and 244. The 436 usable tones include 212 tones on the lower (left, negatively-indexed) side of the carrier frequency, and 224 usable tones on the upper (right, positively-indexed) side of the carrier frequency. The usable tones are partitioned to four partially interleaved dRUs (411a, 411b, 412a, and 412b) across the BW.

In embodiments, the negatively-indexed portion of the BW and the positively-indexed portion of the BW may be symmetric in terms of locations of unusable tones with respect to the carrier frequency corresponding to the tone indexed zero.

Each dRU (411a, 411b, 412a, and 412b) has separate (i.e. individual, different, distinct) 106 usable tones allocated thereto. The tones of a given RU or dRU are distinct in that the tones of one RU or dRU are not tones of another RU or dRU used concurrently. Tone allocation follows a partially interleaved pattern 417 consecutively across the usable tones of the BW. The partially interleaved pattern 415 in this example includes a first tone (e.g indexed-242) allocated to the first dRU 411a, a second tone (e.g indexed-241) consecutive to the first tone and allocated to the second dRU 411b, a third tone (e.g indexed-240) consecutive to the third tone and allocated to the third dRU 412a, a fourth tone (e.g indexed-239) consecutive to the third tone and allocated to the fourth dRU 412b, a fifth tone (e.g indexed-238) consecutive to the fourth tone and allocated to the first dRU 411a, a sixth tone (e.g indexed-237) consecutive to the fifth tone and allocated to the first dRU 411a, a seventh tone (e.g indexed-236) consecutive to the sixth tone and allocated to the second dRU 411b, a eighths tone (e.g indexed-235) consecutive to the sevenths tone and allocated to the second dRU 411b, a ninth tone (e.g indexed-234) consecutive to the eighths tone and allocated to the third dRU 412a, a tenth tone (e.g indexed-233) consecutive to the ninth tone and allocated to the third dRU 412a, a eleventh tone (e.g indexed-232) consecutive to the tenth tone and allocated to the fourth dRU 412b, a twelfth tone (e.g indexed-231) consecutive to the eleventh tone and allocated to the fourth dRU 412b. Such pattern 415 may be referred to herein as “1-2-3-4-1-1-2-2-3-3-4-4” pattern.

The pattern 417, similarly to the pattern 415 described herein with reference to FIG. 4A, may include non-consecutive tones, such as partial pattern 417b and 417c together forming a single complete instance of pattern 417 spaced by 2 null tones 462a. In another example, the pattern 417 may include non-consecutive tones, such as partial pattern 417d and 417e together forming another single complete instance of the pattern 417 spaced by 13 null tones 450a. In an additional example, the pattern 417 may include non-consecutive tones, such as partial pattern 417f and 417g together forming another single complete instance of pattern 417 spaced by 2 null tones 465a. In a further example, the pattern 417 may include non-consecutive tones, such as partial pattern 417h and 417i together forming another single complete instance of pattern 417 spaced by 2 null tones 466a, 23 DC tones 451, and another 2 null tones 467.

In case there is an insufficient number of usable tones remaining at the higher end of the BW to allocate the pattern 417 in full as described above, the pattern may include fewer tones, such as pattern instance 4171 having 8 tones fewer, while maintaining the same tone allocation sequence (i.e. from left to right). Therefore, the allocation 403 includes 35 complete pattern instances (only some are illustrated for ease of illustration) of the 12-tone repeat pattern 417, and one incomplete instance 4171 on the left-most end of the BW that includes only 4 tones.

In an embodiment, the tones across the 40 MHz OFDMA BW may be allocated as illustrated in FIGS. 5A and 5B, by way of example. In the illustrated allocation, the tones of the first dRU 411a and the second dRU 411b are scheduled to a first device (and the tones of the third dRU 412a and the second dRU 412b are scheduled to a second device).

More generally, given four available dRUs, a pair of dRUs can be scheduled to a given device in 6 distinct ways. The first such way, as stated above, involves the tones of the first dRU 411a and the second dRU 411b being scheduled to the given (e.g. first) device (e.g. STA or AP). The second way involves the tones of the first dRU 411a and the third dRU 412a being scheduled to the given device. The third way involves the tones of the first dRU 411a and the fourth dRU 412b being scheduled to the given device. The fourth way involves the tones of the second dRU 411b and the third dRU 412a being scheduled to the given device. The fifth way involves the tones of the second dRU 411b and the fourth dRU 412b being scheduled to the given device. The sixth way involves the tones of the third dRU 412a and the fourth dRU 412b being scheduled to the given device. If there is also a second device (e.g. another STA or another AP), one or both of the remaining (i.e. not allocated to the first device) dRUs may be scheduled to that second device. Thereby, six distinct 106+106 dRU tone plans or allocations can be provided for the first device across the 40 MHz OFDMA BW for two dRUs associated with the first device.

In an embodiment, both of the remaining dRUs not allocated to the first device as described above may be scheduled to the second device in corresponding 6 distinct ways based on allocations to the first device described above. (Note that, once two dRUs are scheduled to the first device, only one of the following schedules may be available for use.) The first way involves the tones of the third dRU 412a and the fourth dRU 412b being scheduled to the second device. The second way involves the tones of the second dRU 411b and the fourth dRU 412b being scheduled to the second device. The third way involves the tones of the second dRU 411b and the third dRU 412a being scheduled to the second device. The fourth way involves the tones of the first dRU 411a and the fourth dRU 412b being scheduled to the second device. The fifth way involves the tones of the first dRU 411a and the third dRU 412a being scheduled to the second device. The sixth way involves the tones of the first dRU 411a and the second dRU 411b being scheduled to the second device. Thereby, six distinct 106+106 dRU tone plans or allocations can be scheduled to the second device across the 40 MHz OFDMA BW for two dRUs associated with the second device in accordance with the 106+106 dRU tone plans or allocations provided for the first device for the respective two dRUs associated therewith. Alternatively, just one of the remaining dRUs can be scheduled to the second device, with the remaining dRU being unused or scheduled to a third device.

In an embodiment, the two or more (e.g. three) dRUs across the 40 MHz OFDMA BW, each having 106 (different) tones allocated thereto, may be scheduled to a same device.

In an embodiment, the tones across the 40 MHz OFDMA BW may be interleaved. For example, an allocation pattern in such case may consist of two dRUs (e.g. first dRU 411a and second dRU 411b of FIGS. 5A and 5B) assigned (scheduled) to one STA or one AP (i.e. device #1 of FIGS. 5A and 5B) and another two dRUs (e.g. third dRU 412a and fourth dRU 412b of FIGS. 5A and 5B) assigned (scheduled) to another STA or another AP (i.e. device #2 of FIGS. 5A and 5B) such that the respective tones allocated to each dRU are interleaved. Such pattern can include a first tone allocated to the first dRU, a second tone consecutive to the first tone and allocated to the second dRU, a third tone consecutive to the third tone and allocated to the third dRU, a fourth tone consecutive to the third tone and allocated to the fourth dRU, and may be referred to herein as a “1-2-3-4” pattern. Thereby, ones of the 424 usable tones of the 40 MHz OFDMA BW can be equally allocated among the four dRUs, each dRU having 106 individual tones spanning the 40 MHz OFDMA BW allocated thereto. As readily understood by a person skilled in the art, similarly to the six distinct dRU tone plans or allocations described elsewhere herein with reference to FIGS. 5A and 5B, six distinct dRU tone plans or allocations can be provided for the “1-2-3-4” tone allocation pattern based on scheduling at least one pair of different dRUs of the four possible dRUs each having 106 tones allocated thereto across the 40 MHz OFDMA BW, to a same device (e.g. STA).

Similar embodiments to the 40 MHz case as described above can be implemented in an 80 MHz band, to provide for 80 MHz dRU tone plans. For example, there can be eight different 106-tone dRUs in an 80 MHz dRU tone plan. In some embodiments, according to an MdRU approach, two of these different 106-tone dRUs can be scheduled to a single STA or AP. Given the eight different 106-tone dRUs, there may be many different combinations of pairs of 106-tone dRUs that can be scheduled to a single STA or AP in this way. Some or all of these may be made available for use. Similarly, in some embodiments, three or more 106-tone dRUs can be scheduled to a single STA or AP.

According to embodiments, use of two different 106-tone dRUs in an 80 MHz dRU tone plan may provide for a transmit power improvement by about 4 times, and/or mitigate or minimize the sacrifice on the data rate compared to scheduling only one 106-tone dRU to a STA or AP. More generally, more sub-carriers can be assigned with the data transmitted in a high BW-based PPDU. The BW basis of a PPDU may refer to the bandwidth covered by the tones used in transmitting the PPDU, e.g. where the tones may be spread across such a bandwidth. In this manner, one can obtain the benefit of TX power boost gain with the data rate sacrifice limited or minimized.

In embodiments, the dRU tone allocations or dRU tone plans, such as those described with reference to FIGS. 4A and 4B, include usable and unusable tones that are respectively aligned. For example, the 12 guard tones 441 are immediately followed by 2 null tones 461 that are spaced from the 2 null tones 462 by 52 usable tones (i.e. from tone indexed-114 through tone indexed-63), the 2 null tones 462 are spaced from 4 null tones 463 by 54 usable tones (i.e. from tone indexed -60 through tone indexed-7) which are followed by 5DC tones 450 immediately followed by 4 null tones 464, etc. Therefore, the unusable tones of a partially interleaved 106+106 tone allocation of FIG. 4A are aligned with the unusable tones of an (i.e., fully) interleaved 106+106 tone allocation of FIG. 4B. The unusable tones in these two allocations are at the same positions. Similarly, the unusable tones in some or all tone plans as described herein, of the same bandwidth or of different bandwidths, can be at the same positions.

More generally, comparing the respective 106+106 dRU allocations shown in FIGS. 4A and 4B with FIGS. 5A and 5B or FIG. 6, and FIGS. 5A and 5B with FIG. 6, the unusable tones of respective tone allocations for the 20 MHz BW are substantially aligned with the unusable tones of respective tone allocations for the 40 MHz BW. In other words, the unusable tones of a 106+106 tone allocation (i.e. dRU tone plan) are substantially the same unusable tones in the lower or the higher 20 MHz frequency portion for the 40 MHz BW.

In embodiments, in a case of a mixed scheduling, the tones are aligned starting from the lowest-indexed tone of each respective BW (i.e. left most tone such as tone indexed-128 in FIGS. 4A, 4B and 6, and tone indexed-256 in FIG. 5A). For example, the 12 guard tones 441 of FIGS. 4A, 4B and 6 are aligned with the 12 guard tones 441a of FIG. 5A; the 2 null tones 461 of FIGS. 4A, 4B and 6 are aligned with the 2 null tones 461a of FIG. 5A; the 2 null tones 462 of FIGS. 4A, 4B and 6 are aligned with the 2 null tones 462a of FIG. 5A; the sequence of null tones 463, 5DC tones 450 and 4 null tones 464 of FIGS. 4A, 4B and 6 are aligned with the 13 null tones 450a of FIG. 5A, etc. In other words, the larger BW (such as the 40 MHz BW) is configured to be an integer multiple of the smaller BW (such as the 20 MHz BW). The larger BW may be partitioned into a plurality of equal-bandwidth portions each corresponding to the smaller BW (that is, each portion of the larger BW having the same bandwidth as the smaller BW). The unusable tones and dRUs of each portion of the larger BW are substantially aligned with the unusable tones and dRUs of the smaller BW, respectively, with the meaning of “align” or “alignment” same as those terms described above. Thereby, mixed scheduling employing respective 106+106 tone plans for dRUs or RUs associated to each device (e.g. STA or AP) across different BWs may be provided for a communication system.

In embodiments, such substantial alignment of unusable tones, at least in part, enables mixed bandwidth scheduling (i.e. different devices may use different operating BWs for transmission of data substantially at the same time). For example, one device using the 20 MHz operating BW may be scheduled in either the lower 20 MHz frequency portion (e.g. negatively indexed tones of FIGS. 5A-B) or the higher 20 MHz frequency portion (e.g. positively indexed tones of FIGS. 5A-B) of the 40 MHz dRU based PPDU. An indication may be included, for example, in the signal (SIG) field of the PPDU indicating (e.g. possibility or enablement) that the PPDU can be or is scheduled with the 20 MHz dRU tone plan in both lower and upper 20 MHz frequency portions of the 40 MHz PPDU. That is, both the device using the 20 MHz operating BW and the device using the 40 MHz operating BW may be scheduled in one 40 MHz PPDU. The BW indication in the SIG field may be 40 MHz, for example, and the device using the 20 MHz operating BW and the device using the 40 MHz operating BW may both be scheduled in either upper or lower 20 MHz frequency portion of the 40 MHz PPDU using the 20 MHz 106+106 dRU tone plan. Thus, both the 20 MHz 106+106 dRU tone plan and the 40 MHz 106+106 dRU tone plan may be mix-used in one 40 MHz PPDU.

In some embodiments where mixed bandwidth scheduling is used, one of the lower or higher 20 MHz frequency portion of a 40 MHz BW may be scheduled as dRUs and the other one of the lower or higher 20 MHz frequency portion may be scheduled as (regular) RUs. More generally, in case two (or more) RUs each having 106 distinct usable tones are allocated to a device, a first RU may span a first portion of an overall bandwidth BW and the second RU may span a second portion, different from the first, of the overall BW. Such portions may be adjacent in frequencies, with an exception of any potential unusable tones as the case may be. For example, one 106 tone RU may span a first lowest portion (i.e., approximately 0-10 MHz considering unusable tones) of a 40 MHz overall BW, while the other 106 tone RU spans the adjacent next lowest portion (i.e., approximately 10-20 MHz considering unusable tones) of the 40 MHz overall BW, thereby the two portions are adjacent. In some cases, such portions may be non-adjacent in frequency. For example, one 106 tone RU may span a first lowest portion (i.e., approximately 0-10 MHz considering unusable tones) of a 40 MHz overall BW, while the other 106 tone RU spans the uppermost portion (i.e., approximately 30-40 MHz considering unusable tones) of the 40 MHz overall BW, thereby the two portions are non-adjacent.

In embodiments, each of at least two devices of a communication network may be scheduled to use a different respective set of dRUs, where each set includes two or more dRUs and the sets are non-overlapping. Respective 106 usable tones of a plurality of usable tones spanning at least a portion of the BW may be allocated to a first dRU, and respective 106 usable tones, distinct from the 106 usable tones allocated to the first dRU, of the plurality of usable tones spanning at least the portion of the BW, may be allocated to a second dRU. The first dRU and the second dRU may be scheduled to a first device operable in the communication network. Another respective 106 usable tones of the plurality of usable tones spanning at least another portion of the BW may be allocated to a third dRU, and further respective 106 usable tones of the plurality of usable tones spanning at least the other portion of the BW may be allocated to a fourth dRU. The third dRU and the fourth dRU may be scheduled to a second device operable in the communication network.

In an embodiment, the methods and systems described herein may be used to provide allocated tones to two RUs assigned (scheduled) to one STA or one AP. These RUs may be contrasted with dRUs, in that the carriers thereof are all contiguous. For example, embodiments may schedule two 106-tone RUs to a same STA (or same AP). Thus, an MRU comprising two 106-tone RUs, thus forming a 106+106 tone MRU can be provided and supported. In various embodiments, the two component 106-tone RUs can be substantially contiguous, e.g. separated by null subcarriers or DC components. In some embodiments, the two component 106-tone RUs can be non-contiguous, e.g. separated by other possible 106-tone RUs. In some embodiments, an MRU comprising three or more RUs (at least two having 106 tones) may be similarly provided.

FIG. 6 shows allocation 404 of tones across a 20 MHz OFDMA BW (having 256 tones in total, based on the 78.125 kHz subcarrier spacing) to two RUs assigned (scheduled) to a same STA or same AP such that the respective tones allocated to each RU are not interleaved, according to an embodiment. As shown, the 20 MHz OFDMA BW has 44 unusable tones and 212 usable tones as described previously with reference to FIG. 4A.

A first RU 413a has 106 usable tones allocated thereto in the negatively indexed BW (i.e. to the left of the carrier frequency indexed as tone zero), and the second RU 413b has 106 usable tones allocated thereto in the positively indexed BW (i.e. to the right of the carrier frequency indexed as tone zero). Tone allocation follows two instances of non-interleaved pattern 418, one instance includes partial patterns 418a and 418b separated by 2 null tones 462, and the other instance includes partial patterns 418c and 418d separated by 2 null tones 465. A second, separate allocation pattern to the one illustrated may be provided where the first RU 413a has associated tones in the positively indexed BW (i.e. corresponding to partial patterns 418c and 418d), while the second RU 413b has associated tones in the negatively indexed BW (i.e. corresponding to partial patterns 418a and 418b).

In an embodiment, similarly to the above and as readily understood by a person skilled in the art, tones across a (e.g., 20 MHz) OFDMA BW may be allocated to two RUs associated with (scheduled to) one STA or one AP, and another two RUs associated with (scheduled to) another STA or another AP, in six different ways (allocations or tone plans) such that the respective tones of each RU are non-interleaved.

In embodiments, the MdRU tone pattern may include any partially or fully-interleaved tone allocation sequence spanning a BW that includes 106 usable tones allocated to one dRU associated or allocated to a device (such as an STA or an AP) and another 106 usable tones to another dRU associated to the same device (such as the same STA or the same AP). For example, the 106 usable tones of one dRU allocated to the device may be fully (e.g., as in FIG. 4B) or partially (e.g., as in FIG. 4A) interleaved with the 106 usable tones of another dRU allocated to a same device. Notably, respective 106 tones of each dRU, irrespective of the associated device, are distinct and allocated only to the respective dRU. Interleaving advantageously enables each dRU to span the same bandwidth. In case or another two (or more) dRUs allocated to a second device, dRUs for both devices may be scheduled and be operable simultaneously (i.e., as along as the bandwidth permits), for example as described herein with reference to FIGS. 5A-5B where all four dRUs (two dRUs per device) are, by way of an example, partially interleaved forming a “1-2-3-4-1-1-2-2-3-3-4-4” tone allocation pattern that repeats across the whole bandwidth (i.e., the usable tones thereof). Other example tone allocation patterns may be provided, such as a “1-2-3-4” fully interleaved tone allocation pattern that repeats across the whole bandwidth (i.e., the usable tones thereof).

In some embodiments, fully or partially interleaved dRUs allocated to one device may span a distinct portion of the BW than the fully or partially interleaved dRUs allocated to another device. For example, two 106 tone dRUs allocated to one device may be interleaved across the lower 20 MHz of a 40 MHz overall bandwidth, while the two 106 tone dRUs allocated to another device may be interleaved across the upper 20 MHz portion of the overall 40 MHz bandwidth. Such portions are, therefore, non-overlapping.

In embodiments, scheduling as described herein with reference to the above examples and embodiments may be referred to generally as a 106+106 tone plan or tone allocation. The tone plan can be a dRU tone plan, formed of tones from two (or more) dRUs. The tone plan can be a rRU tone plan, formed from tones of two (or more) rRUs. The tone plan can be a mixed tone plan formed from tones of a (at least one) dRU and tones of a (at least one) rRU. The 106+106 dRU tone plan includes allocating 106 tones to one dRU associated with a device (e.g. STA, AP) and allocating another 106 tones to another dRU associated with the same device, such that the 106 tones and the other 106 tones span (e.g., all, depending on the BW) usable tones across the BW. Scheduling two or more dRUs or two or more RUs, each having 106 tones allocated thereto, to a same device advantageously provides more subcarriers (i.e. tones) for the device, thereby providing an increased power boost gain for transmission of data to or from the device while minimizing a reduction in data rate commonly associated with bandwidth sharing across multiple devices.

In embodiments, the methods and system disclosed herein are applicable to mixed scheduling at higher BWs, such as 80 MHz OFDMA BW, 160 MHz OFDMA BW, and 320 MHz OFDMA BW.

It is noted that in a 40 MHz or larger (e.g. 80 MHz, 160 MHz or 320 MHz) bandwidths might, at least in some scenarios, accommodate at least one 242-tone dRU, with tones potentially spanning the entire band and at least some tones being non-adjacent. However, in view of the number of “unusable” tones being used e.g. as DC tones, guard tones and null tones, it is difficult to define a 242-tone dRU in a 20 MHz band. It is therefore also difficult to define a 242-tone dRU in larger bands, for example because the dRU in the smaller 20 MHz band is often used as a template for defining the 242-tone dRU in larger bands. Embodiments may provide for a solution to replace such a 242-tone dRU. In particular, the replacement may be a MdRU having 106+106 tones, which gives a comparable number of tones as the 242-tone dRU. The MdRU may thus comprise two 106-tone dRUs, which may be interleaved with one another. Thus, according to embodiments, where a 242-tone dRU would be appropriate, it may nevertheless be replaced with a 106+106 tone MdRU. An outcome can be that a transmit power boost gain is realized with limited sacrifice in data rate.

Similarly, rather than an MdRU, an MRU comprising two 106-tone RUs can be defined, scheduled and used. The tones of each of the RUs can be contiguous, with the possible exception of unusable tones, if present. The two RUs can be contiguous with one another, i.e. adjacent in frequency, again with the possible exception of unusable tones, if present. The two RU can be separated in frequency, for example with one or more usable tones between the tones of the first RU and the tones of the second RU. The locations of the tones of the two RUs define an RU (or rRU) tone plan.

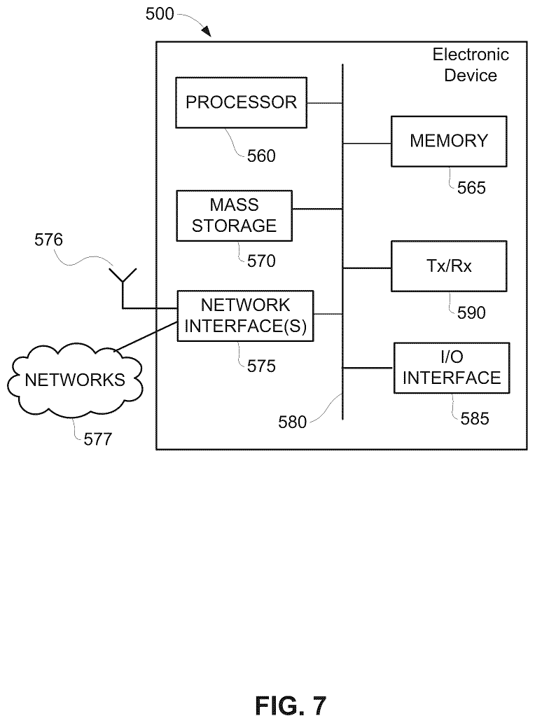

FIG. 7 shows a schematic diagram of an electronic device 500 that may perform any or all of the operations of the above methods and features explicitly or implicitly described herein, according to different embodiments of the present disclosure. For example, a computer equipped with network function may be configured as electronic device 500. The electronic device 500 may be used to implement the embodiments of any one or more of FIGS. 4-6, for example.

As shown, the electronic device 500 may include a processor 560, such as a Central Processing Unit (CPU) or specialized processors such as a Graphics Processing Unit (GPU), a Neural Processing Unit (NPU) or other such processor unit, memory 565, network interface 575, and a bi-directional bus 580 to communicatively couple the components of electronic device 500. Electronic device 500 may also include as needed non-transitory mass storage 570, an I/O interface 585, and a transceiver 590. According to certain embodiments, any or all of the depicted elements may be utilized, or only a subset of the elements. Further, the electronic device 500 may contain multiple instances of certain elements, such as multiple processors, memories, or transceivers. Also, elements of the hardware device may be directly coupled to other elements without the bi-directional bus 580. Additionally or alternatively to a processor and memory, other electronics, such as integrated circuits, may be employed for performing the required logical operations.

The memory 565 may include any type of tangible, non-transitory memory such as static random access memory (SRAM), dynamic random access memory (DRAM), synchronous DRAM (SDRAM), read-only memory (ROM), any combination of such, or the like. The mass storage element 830 may include any type of tangible, non-transitory storage device, such as a solid state drive, hard disk drive, a magnetic disk drive, an optical disk drive, USB drive, or any computer program product configured to store data and machine executable program code. According to certain embodiments, the memory 565 or mass storage 570 may have recorded thereon statements and instructions executable by the processor 560 for performing any of the aforementioned method operations described above.

Network interface(s) 575 may include at least one of a wired network interface and a wireless network interface. The network interface 575 may include a wired network interface to connect to a communication network 577 and may also include a radio access network interface 576 for connecting to the communication network or other network elements over a radio link. The network interface 575 enables the electronic device 500 to communicate with remote entities such as those connected to the communication network 577.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product may include a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via an electronic element depending on the particular context. The term “and/or” herein when used in association with a list of items means any one or more of the items comprising that list.

Although a combination of features is shown in the illustrated embodiments, not all of them need to be combined to realize the benefits of various embodiments of this disclosure. In other words, a system or method designed according to an embodiment of this disclosure will not necessarily include all features shown in any one of the Figures or all portions schematically shown in the Figures. Moreover, selected features of one example embodiment may be combined with selected features of other example embodiments.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method for supporting usage, by a device, of a communication network using orthogonal frequency division multiple access (OFDMA), the method comprising:
allocating, to the device and for concurrent use in transmission: a first 106 usable tones of a plurality of usable tones; and
a second 106 usable tones, distinct from the first 106 usable tones, of the plurality of usable tones;
wherein the first 106 usable tones are allocated to a first resource unit (RU) or a first distributed resource unit (dRU), and the second 106 usable tones are allocated to a second RU or a second dRU.

2. The method of claim 1, wherein the first RU or the first dRU is the first RU, and wherein the second RU or the second dRU is the second RU.

3. The method of claim 2, wherein the first RU spans a first portion of an overall bandwidth (BW) and the second RU spans a second portion of the overall BW, the second portion being different from the first portion.

4. The method of claim 3, wherein the first portion is adjacent in frequency to the second portion.

5. The method of claim 1, wherein the first RU or the first dRU is the first dRU, and wherein the second RU or the second dRU is the second dRU, and wherein the first dRU and the second dRU span a same bandwidth (BW).

6. The method of claim 5, wherein at least two neighbouring usable tones of the first 106 usable tones are separated by one or more usable tones of the second 106 usable tones.

7. The method of claim 5, wherein the first 106 usable tones are partially or fully interleaved with the second 106 usable tones.

8. The method of claim 1, further comprising:
allocating usage, by a second device of the communication network using OFDMA, the usage being concurrent with the usage by the device and the allocating usage comprising:
allocating, to the second device and for concurrent use in transmission: a third 106 usable tones, distinct from the first 106 usable tones and the second 106 usable tones, of the plurality of usable tones; and
a fourth 106 usable tones, distinct from the first 106 usable tones and the second 106 usable tones and the third 106 usable tones, of the plurality of usable tones;
wherein the third 106 usable tones are allocated to a third RU or a third dRU, and the fourth 106 usable tones are allocated to a fourth RU or a fourth dRU.

9. The method of claim 8, wherein the third RU or the third dRU is the third RU, and wherein the fourth RU or the fourth dRU is the fourth RU.

10. The method of claim 8, wherein the third RU or the third dRU is the third dRU, and wherein the fourth RU or the fourth dRU is the fourth dRU, wherein the first dRU and the second dRU span a same first bandwidth (BW), and the third dRU and the fourth dRU span a same second BW.

11. The method of claim 10, wherein the first BW is non-overlapping with the second BW.

12. The method of claim 8, wherein method is performed by a scheduler, and wherein the allocating the first RU or the first dRU, the second RU or the second dRU to the device, and the allocating the third RU or the third dRU and the fourth RU or the fourth dRU to the second device, comprises scheduling of RUs or dRUs.

13. The method of claim 8, wherein the method is performed by the device and the second device in combination, the method further comprising: transmitting one or more of: the first RU or the first dRU; the second RU or the second dRU; the third RU or the third dRU; and the fourth RU or the fourth dRU.

14. The method of claim 1, wherein the communication network conforms to the IEEE 802.11be standard or an IEEE 802.11 standard subsequent to the IEEE 802.11be standard.

15. The method of claim 1, wherein the method is performed by a scheduler, and wherein the allocating the first RU or the first dRU, the second RU or the second dRU to the device, comprises scheduling of the first RU or the first dRU and scheduling of the second RU or the second dRU.

16. The method of claim 1, wherein the method is performed by the device, the method further comprising: transmitting one or both of: the first RU or the first dRU; and the second RU or the second dRU.

17. The method of claim 1, wherein one or more unusable tones, different from the first 106 usable tones and the second 106 usable tones are defined, and wherein the first RU, the first dRU, the second RU and the second dRU are selected from a plurality of potential tone plans, and each of the plurality of potential tone plans exclude the one or more unusable tones.

18. An apparatus for supporting usage, by a device, of a communication network using orthogonal frequency division multiple access (OFDMA), the apparatus comprising processing electronics and a wireless transmitter and configured to:
allocate, to the device and for concurrent use in transmission:
a first 106 usable tones of a plurality of usable tones; and
a second 106 usable tones, distinct from the first 106 usable tones, of the plurality of usable tones;
wherein the first 106 usable tones are allocated to a first resource unit (RU) or a first distributed resource unit (dRU), and the second 106 usable tones are allocated to a second RU or a second dRU.

19. The apparatus of claim 18, wherein the apparatus is a scheduler or the device.

20. An apparatus for scheduling usage, by a first device and a second device, of a communication network using orthogonal frequency division multiple access (OFDMA), the apparatus comprising processing electronics and a wireless transmitter and configured to:
schedule, to the first device, for concurrent use in transmission:
a first 106 usable tones of a plurality of usable tones; and
a second 106 usable tones, distinct from the first 106 usable tones, of the plurality of usable tones; and
scheduling usage, by the second device, of the communication network using OFDMA, the usage being concurrent with the usage by the device and the scheduling usage comprising:
scheduling, to the second device, for concurrent use in transmission:
a third 106 usable tones, distinct from the first 106 usable tones and the second 106 usable tones, of the plurality of usable tones; and
a fourth 106 usable tones, distinct from the first 106 usable tones and the second 106 usable tones and the third 106 usable tones, of the plurality of usable tones;
wherein the first 106 usable tones are allocated to a first resource unit (RU) or a first distributed resource unit (dRU), the second 106 usable tones are allocated to a second RU or a second dRU, the third 106 usable tones are allocated to a third RU or a third dRU, and the fourth 106 usable tones are a fourth RU or a fourth dRU.
